(19) United States
(12) Patent Application Publication
(10) Pub. No.: US 2018/0247351 A1
(43) Pub. Date: Aug. 30, 2018

(54) WASTE MANAGEMENT SYSTEM HAVING PARTNER MARKETPLACE

(71) Applicant: Rubicon Global Holdings, Inc., Altanta, GA (US)

(72) Inventor: Philip RODONI, Decatur, GA (US)

(73) Assignee: Rubicon Global Holdings, Inc., Altanta, GA (US)

(21) Appl. No.: 15/442,978

(22) Filed: Feb. 27, 2017

(51) Int. Cl. G06Q 30/06; G06Q 30/02; H04L 29/08

(52) U.S. Cl. CPC G06Q 30/0601; G06Q 50/26; H04L 67/18; G06Q 30/0207

(57) ABSTRACT

A system is disclosed for managing waste services. The system may include first portals configured to receive waste-related asset information from customers, second portals configured to receive waste-related asset information from vendors, and a central processing unit in electronic communication with first and second portals. The central processing unit may be configured to monitor operation of customer assets based on the waste-related asset information received from the customers, and to make a determination that an operating parameter of a particular customer asset has deviated from an acceptable range based on the monitored operation. The central processing unit may be further configured to automatically complete a sales transaction with a particular one of the vendors on behalf of a particular one of the customers based on the determination and based on the waste-related asset information received from the vendors.

### TECHNICAL FIELD

The present disclosure relates generally to a management system and, more particularly, to a waste management system having a partner marketplace.

### BACKGROUND

Conventional waste removal is accomplished by both independent haulers and multi-regional service providers. The independent haulers may have one or more service vehicles that service established routes on a periodic (e.g., daily) basis to retrieve waste from residential customers. The multi-regional service providers employ fleets of waste service vehicles to retrieve waste from larger commercial customers based on contracts for multiple service locations.

The service vehicles of both the independent haulers and the multi-regional service providers must be serviced on a regular basis in order for the vehicles to continue operation. For example, the vehicles must be fueled, worn tires must be replaced, and repairs must be made. The multi-regional service providers may enjoy lower pricing for fuel, parts, and service due to their ability to purchase in higher volumes. This can place the independent haulers at a disadvantage, as they must pay full price for any vehicle-related expenses.

Regardless of the volume-discount pricing that haulers may or may not be privy to, it can be difficult to manage the maintenance and repair of the service vehicles. In particular, it can be difficult to keep track of when maintenance should be completed and when parts should be ordered for timely repairs. This can result in extended downtime of the service vehicles and a loss in profit.

The disclosed system is directed to overcoming one or more of the problems set forth above and/or other problems of the prior art.

### SUMMARY

In one aspect, the present disclosure is directed to a system for managing waste-related activities. The system may include a plurality of first portals configured to receive waste-related asset information from a plurality of customers, a plurality of second portals configured to receive waste-related asset information from a plurality of vendors, and a central processing unit in electronic communication with the pluralities of first and second portals. The central processing unit may be configured to monitor operation of customer assets based on the waste-related asset information received from the plurality of customers, and to make a determination that an operating parameter of a particular customer asset has deviated from an acceptable range based on the monitored operation. The central processing unit may be further configured to automatically complete a sales transaction with a particular one of the plurality of vendors on behalf of a particular one of the plurality of customers based on the determination and based on the waste-related asset information received from the plurality of vendors.

In another aspect, the present disclosure is directed to method for managing waste-related activities. The method may include receiving waste-related asset information from a plurality of customers, receiving waste-related asset information from a plurality of vendors, and monitoring operation of customer assets based on the waste-related asset information received from the plurality of customers. The method may also include making a determination that an operating parameter of a particular customer asset has deviated from an acceptable range based on the monitored operation, and automatically completing a sales transaction with a particular one of the plurality of vendors on behalf of a particular one of the plurality of customers based on the determination and based on the waste-related asset information received from the plurality of vendors.

In yet another aspect, the present disclosure is directed to a non-transitory computer readable medium containing computer-executable program instructions for performing a method of managing waste-related activities. The method may include receiving information from a plurality of customers in association with one of a waste service vehicle and a receptacle owned by the plurality of customers, and receiving information from a plurality of vendors regarding one of a product and a service available for the waste service vehicle or the receptacle. The method may also include monitoring operation of the waste service vehicle or the receptacle based on the information received from the plurality of customers, and making a determination that an operating parameter of a particular waste service vehicle or receptacle has deviated from an acceptable range based on the monitored operation. The method may further include automatically completing a sales of the product or the service with a particular one of the plurality of vendors on behalf of a particular one of the plurality of customers based on the determination and based on the information received from the plurality of vendors. The plurality of vendors provide discount pricing to the plurality of customers in exchange for high-volume sales collectively transacted on behalf of the plurality of customers.

### BRIEF DESCRIPTION OF THE DRAWINGS

FIG. 1 is an isometric illustration of an exemplary disclosed waste management environment;

FIG. 2 is a diagrammatic illustration of an exemplary disclosed system that may be used to manage the environment of FIG. 1; and

FIG. 3 is a flowchart depicting an exemplary method that may be performed by the system of FIG. 2.

### DETAILED DESCRIPTION

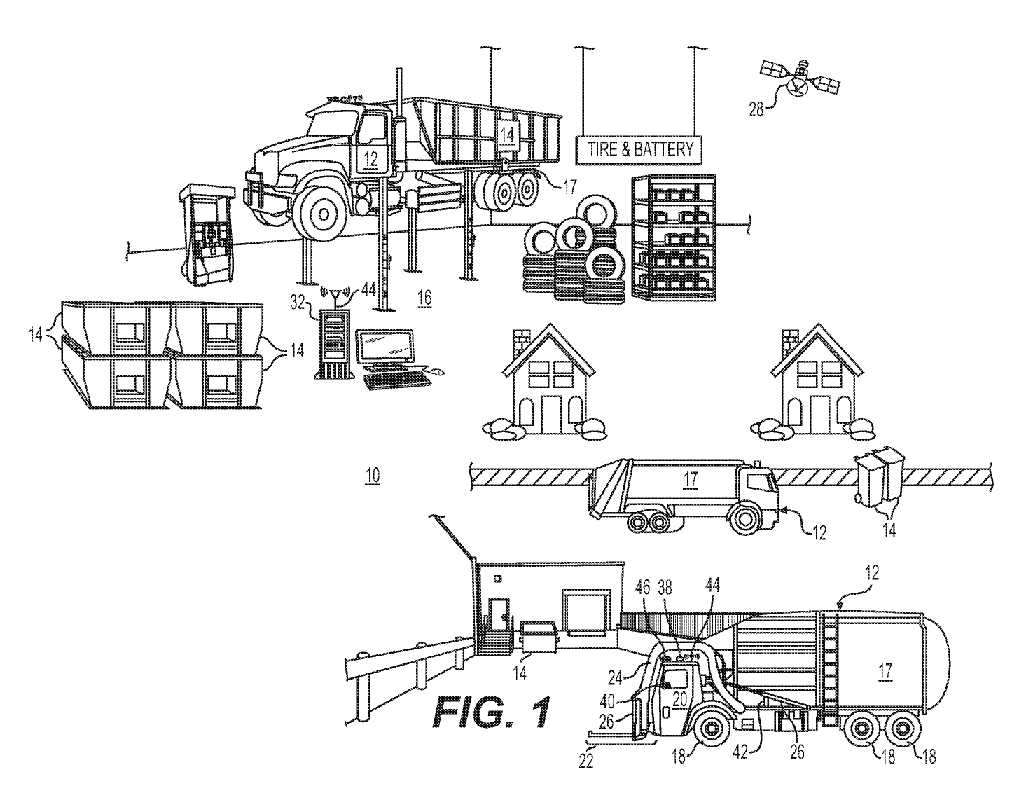

FIG. 1 illustrates an exemplary waste management environment (“environment”) 10, at which multiple vehicles 12 are operating. Environment 10 may include a retail store, a factory, a government building, a residential address, and/or another location having one or more receptacles 14 that require the services of vehicles 12. The services may include, for example, the removal of waste materials from inside of receptacle(s) 14, the replacement of receptacle(s) 14, and/or the placement of additional receptacles 14. Environment 10 may also include a partner marketplace 16 (e.g., a purchasing cooperative for participating customers) through which maintenance, repairs, and waste-related (e.g., vehicle- and/or receptacle-related) purchase can be made.

Vehicles 12 may take many different forms. In the lower-right example of FIG. 1, vehicle 12 is a hydraulically actuated, front-loading type of vehicle. Specifically, vehicle 12 may include a bed 17 supported by a plurality of wheels 18, a cab 20 located forward of bed 17, and a lifting device 22 extending forward of cab 20. Lifting device 22 may consist of, among other things, one or more lift arms 24 configured to engage and/or grasp receptacle 14, and one or more actuators 26 powered by pressurized oil to raise lift arms 24 (and receptacle 14) up past cab 20 to a dump location over bed 17. After dumping receptacle 14, pressurized oil may be released from hydraulic actuator(s) 26 to allow lowering of lift arms 24 and receptacle 14 back to the ground in front of vehicle 12.

In other examples (e.g., shown in the upper-right of FIG. 1), vehicle 12 may be located to pick up receptacles 14 from a side and/or a rear of each vehicle 12. In yet other examples (not shown), receptacles 14 may be manually lifted and dumped into bed 17. In a final example, (e.g., shown in upper-left of FIG. 1, inside of partner marketplace 16), vehicle 12 may be configured to load receptacle 14 onto bed 17 of vehicle 12 for transportation away from environment 10. In any of these examples, bed 17 could be outfitted with a compactor (not shown) to compact the waste material after the material is dumped into bed 17, and/or a door (not shown) configured to close an opening of bed 17 through which the waste material is dumped. Other configurations may also be possible.

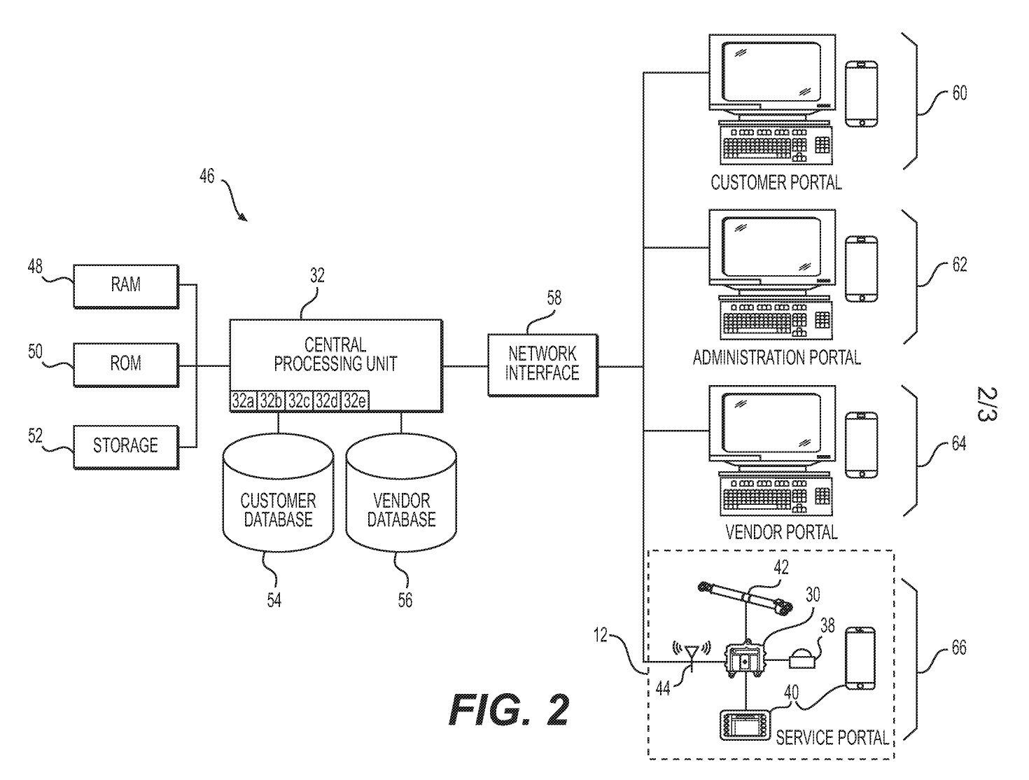

As each vehicle 12 moves about environment 10, a satellite 28 or other tracking device may communicate with an onboard controller 30 (shown only in FIG. 2) to monitor the movements of vehicle 12 and the associated changes made to environment 10 (e.g., pickup, dumping, placement, etc.). As will be explained in more detail below, onboard controller 30 may network with a central processing unit (“CPU”) 32 (e.g., a processing unit located at or otherwise associated with partner marketplace 16—referring to FIG. 1), which may then manage and/or facilitate maintenance and repair of each vehicle 12 based on these movements and changes.

Onboard controller 30 may include means for monitoring, recording, storing, indexing, processing, communicating and/or controlling other onboard and/or offboard devices. These means may include, for example, a memory, one or more data storage devices, a central processing unit, or any other components that may be used to run the disclosed application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM.

Onboard controller 30 may be configured to track, assist, and/or control movements of the associated vehicle(s) 12. In addition to onboard controller 30, each vehicle 12 could additionally include a locating device 38, and at least one of a manual input device 40 and a sensor 42 mounted or otherwise located onboard each vehicle 12. In some embodiments, vehicle 12 is equipped with both manual input device 40 and one or more sensors 42. Onboard controller 30 may be in communication with each of these other components and/or with CPU 32 at partner marketplace 16 (e.g., via a communication device 44), and configured to determine, based on signals from these components and based on other known information stored in memory, the location of each vehicle 12, operational characteristics of vehicle 12, and/or characteristics and locations of receptacles 14 being moved by and/or in a vicinity of each vehicle 12.

Locating device 38 may be configured to generate signals indicative of a geographical position and/or orientation of vehicle 12 relative to a local reference point, a coordinate system associated with environment 10, a coordinate system associated with Earth, or any other type of 2-D or 3-D coordinate system. For example, locating device 38 may embody an electronic receiver configured to communicate with satellites 28, or a local radio or laser transmitting system used to determine a relative geographical location of itself. Locating device 38 may receive and analyze high-frequency, low-power radio or laser signals from multiple locations to triangulate a relative 3-D geographical position and orientation. In some embodiments, locating device 38 may also be configured to determine a location and/or orientation of a particular part of vehicle 12, for example of lift arms 24. Based on the signals generated by locating device 38 and based on known kinematics of vehicle 12, onboard controller 30 may be able to determine in real time the position, heading, travel speed, acceleration, and orientation of vehicle 12 and lift arms 24. This information may then be used by onboard controller 30 and/or CPU 32 to update the locations and conditions of vehicles 12 and/or receptacles 14 in an electronic map or database of environment 10.

Input device 40 may provide a way for an operator of vehicle 12 to input information regarding observances made while traveling around environment 10. For example, the operator may be able to enter a type and/or condition of vehicle 12 being driven by the operator, a type and/or condition of waste observed at a particular location, an amount of waste in or around receptacle 14, a fill status of a particular receptacle 14, a condition of receptacle 14, a location of receptacle 14, and or other information about receptacle 14 and waste engaged by, loaded into, or otherwise processed by vehicle 12. The information may be input in any number of ways, for example via a cab-mounted touch screen interface, via one or more buttons, via a keyboard, via speech recognition, via a smartphone carried by the operator, or in another manner known in the art. In some embodiments, in addition to receiving manual input from an operator, input device 40 may also be capable of displaying information, for example the electronic map of environment 10, instructions and/or alerts from partner marketplace 16, payload information, cycle count, service scheduling, pricing, etc.

Sensors 42 may be configured to monitor parameters associated with vehicle 12, receptacle 14, and/or the waste material loaded from receptacle 14 into vehicle 12, and to generate corresponding signals indicative thereof. Each of these sensors 42 may be any type of device known in the art, and located anywhere on or inside of vehicle 12.

In one example, sensor 42 may embody any one or more of a load cell, a force gauge, a pressure sensor, an angle sensor, a distance sensor, or another type of load detector associated directly with lift arms 24, with actuator(s) 26, and/or with a strut or other structure supporting bed 17. In this example, the signals generated by sensor(s) 42 may correspond with strain on lift arms 24, with a force applied to lift arms 24 by actuator(s) 26, with a range of motion, with a cycle count, and or with a payload weight of bed 17.

Alternatively, one or more sensors 42 may be associated with a power source or drivetrain of vehicle 12, and configured to generate signals indicative of an amount of power used to propel vehicle 12, an engine pressure or temperature, a distance traveled by vehicle 12 (e.g., an odometer reading), etc. The signals generated by these sensors may correspond with a health of vehicle 12.

Other types of sensors 42 (e.g., cameras, spectrometers, IR sensors, RADAR sensors, LIDAR sensors, etc.) may also be utilized to determine characteristics (e.g., load profile, volume, and/or shape) of the waste material inside receptacles 14 or of receptacles 14 themselves. In yet further examples, sensor 42 could be an acoustic sensor, an accelerometer, or another similar type of sensor configured to detect engagement conditions and/or cycle completion of lift arms 24, the in-bed compactor, the door, etc. during lifting, dumping, and/or shaking of receptacle 14. Other types of sensors 42 may alternatively or additionally be utilized. Signals generated by these sensors 42 may be communicated to onboard controller 30, which may use the signals to determine the operating parameters of receptacles 14 and/or vehicle 12.

Onboard controller 30 may be configured to manage communications between other onboard components and CPU 32 located at or otherwise associated with partner marketplace 16. For example, onboard controller 30 may receive signals from locating device 38, input device(s) 40, and sensors 42, and correlate the signals, filter the signals, buffer the signals, record the signals, or otherwise condition the signals before directing the signals offboard via communication device 44.

Communication device 44 may be configured to facilitate communication between onboard controller 30 and offboard CPU 32. Communication device 44 may include hardware and/or software that enable the sending and/or receiving of data messages through a communications link. The communications link may include satellite, cellular, infrared, radio, and any other type of wireless communications. Alternatively, the communications link may include electrical, optical, or any other type of wired communications, if desired. In one embodiment, onboard controller 30 may be omitted, and CPU 32 may communicate directly with locating device 38, input device(s) 40, and/or sensor(s) 42 via communication device 44, if desired. Other means of communication may also be possible.

As shown in FIG. 2, onboard controller 30 (and the other connected onboard components) and CPU 32 may each form a portion of a waste management system (“system”) 46 configured to generate, maintain, send, solicit, confirm, display, offer, receive and/or record information associated with the disclosed concepts. System 46 may include, for example, a random access memory (RAM) 48, a read-only memory (ROM) 50, a storage 52, at least one database (e.g., a customer database 54 and a vendor or product database 56), a network interface 58, and at least one user portal (e.g., a customer portal 60, an administration portal 62, a vendor portal 64, and a service portal 66). As will be explained in more detail below, CPU 32 may be configured to receive data from different users via portals 60-66, and to record, process, and share the data with the same and/or with other users via the same or different portals 60-66. It is contemplated that system 46 may include additional, fewer, and/or different components than those listed above. It is understood that the type and number of listed devices are exemplary only and not intended to be limiting.

CPU 32 may include an arrangement of electronic circuitry configured to perform arithmetic, logic, input/output, and control operations during sequential execution of pre-programmed instructions. The instructions may be loaded from ROM 50 into RAM 48 for execution by CPU 32. It should be noted that, although CPU 32 is shown and described as a single “unit”, it is contemplated that the functions of CPU 32 could alternatively be completed by any number of co-located or remotely distributed and cooperating processing units, as desired. Numerous commercially available microprocessors may be configured to perform the functions of CPU 32. Further, the microprocessors may be general-purpose processors or specially constructed for use in implementing the disclosed concepts.

The functions of CPU 32 may be divided among any number of different modules. In the disclosed embodiment, these modules include an opportunity module 32a, a rating module 32b, a services module 32c, a pricing module 32d, and an administration module 32e. In general, the word “module,” as used herein, refers to a collection of software instructions (e.g., instructions that are compiled and linked into an executable program) or embedded firmware that performs the same function. It will be appreciated that some modules could be callable from other modules or from themselves, and/or can be invoked in response to detected events or interrupts. Modules 32a-e, if embodied as software, may be configured for execution by CPU 32 and provided on a computer readable medium, such as a compact disc, digital video disc, flash drive, magnetic disc, or any other tangible medium, or as a digital download (and can be originally stored in a compressed or installable format that requires installation, decompression, or decryption prior to execution).

Storage 52 may embody any appropriate type of mass storage provided to hold information that CPU 32 may need in order to perform the disclosed processes. For example, storage 52 may include one or more hard disk devices, optical disk devices, or other storage devices that provide sufficient storage space.

Databases 54 and/or 56 may contain model data and any information relating to particular customer, vendor, and/or product records under analysis. The information stored within databases 54 and/or 56 may come from any source known in the art and be provided at any time and frequency. For example, the information could be manually entered based on recorded statistics and/or live observations, automatically retrieved from an external server based on a predetermined schedule, continuously streamed from a customer or vendor site, spontaneously uploaded by users via portals 60-66, intermittently pulled from “the cloud,” downloaded from sensor(s) 42, and/or obtained in any other manner at any other time and frequency. In addition to the customer, vendor, and/or product information, databases 54 and/or 56 may also include tools for analyzing the information stored therein. CPU 32 may use databases 54 and/or 56 to determine relationships and/or trends relating to particular customers, particular vehicles 12, particular receptacles 14, particular vendors, particular products, and/or particular users of system 46, and other such pieces of information. CPU 32 may pull information from databases 54 and/or 56, manipulate the information, and analyze the information. CPU 32 may also update the information, store new information, and store analysis results within databases 54 and/or 56, as desired.

CPU 32 may communicate with a user of system 46 (e.g., a user accessing any one of portals 60-66) via network interface 58. Network interface 58 may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components. For example, the communication links may include non-proprietary links and protocols, or proprietary links and protocols based on known industry standards, such as J1939, RS-234, RP1210, RS-422, RS-485, MODBUS, CAN, SAEJ1587, Bluetooth, the Internet, an intranet, 802.11 (b, g, n, ac, or ad), or any other communication links and/or protocols known in the art.

Each of portals 60-66 can include one or more of a router, an Ethernet bridge, a modem (e.g., a wired or wireless modem), or any other conventional computing components known in the art (not shown) such as a processor, input/output (I/O) ports, a storage, and a memory. The processor of each portal 60-66 can include one or more processing devices, such as microprocessors and/or embedded controllers. The storage can include volatile or non-volatile, magnetic, semiconductor, tape, optical, removable, non-removable, or other type of computer-readable medium or computer-readable storage device. The storage can be configured to store software programs (e.g., apps) downloaded from CPU 32 via network interface 58 and/or other information that can be used to implement one or more of the disclosed processes. The memory can include one or more storage devices configured to store the downloaded information. Each of portals 60-66 may be able to communicate with CPU 32, with databases 54 and/or 56, and/or directly with another of portals 60-66 via network interface 58.

Each of portals 60-66 may provide a graphical user interface (GUI) that is configured to display information to users thereof, and that includes a means for receiving input from the user. In one embodiment, an exemplary portal is a computer (e.g., a laptop or desktop computer) having a console and a keyboard/mouse. In another embodiment, an exemplary portal is a handheld mobile device, such as a smart phone or a tablet having a touchscreen display and/or a keyboard. Other types of portals may also be utilized. The GUIs of portals 60-66 may allow the user to receive (e.g., visually and/or audibly) information from system 46 via network interface 58, to upload information to system 46, and/or to correspond with other users of system 46.

Portal 60 may be dedicated for use by a customer of partner marketplace 16 (i.e., a partner of the purchasing cooperative). The customer may be, for example, an owner or operator of a service vehicle 12 (and/or receptacle 14) for whom an account is established with the provider of system 46, or a new owner or operator for whom an account is desired. It is contemplated that any number of portals 60 may be simultaneously connected to network interface 58 for use by any number of different customers. Each such portal 60 may allow the customer to log into system 46 (e.g., via a web-based program, an internet site, or a mobile app) and to view statistics (current and/or historic statistics) associated with the owner's vehicle 12, to view statistics of receptacles 14 owned by the customer and/or being serviced by the vehicle 12, to view recommended and/or scheduled maintenance or repair activities for the vehicle 12 and/or receptacles 14, to view recommended products (e.g., fuel, tires, batteries, replacement parts, new/used vehicles, new/used receptacles, etc.), to view details about promotional events, to receive technical and/or service updates, etc. Each portal 60 may additionally allow the customer to input information regarding vehicles 12 and/or receptacles 14, to schedule maintenance and/or repair activities, to purchase products at discount prices, and/or to place inquiries regarding desired productions and/or services. In some embodiments, portal 60 may be further capable of providing live or near-live feedback (e.g., GPS tracking, lift-arm tracking, and/or live onboard video feed) during servicing, during repair, etc., if desired. Other forms of information could also be provided to the customer via portal 60.

Administration portal 62 may be dedicated for use by an administrator of system 46 (e.g., an account representative, a sales associate, a service manager, an IT manger, etc.). It is contemplated that any number of portals 62 may be simultaneously connected to network interface 58 for use by any number of different administrators associated with the same or different customer accounts. Each such portal 62 may allow the administrator to log into system 46 (e.g., via a web-based program, an internet site, or a mobile app) and to address a maintenance or repair request, to alert a customer regarding abnormal operation of a vehicle 12 and/or receptacle 14, to recommend a maintenance and/or repair request, to confirm ordering and/or purchase of an automatically recommended component or service, to manage a particular customer account, to create new customer accounts, to solicit services and/or products from existing vendors, to generate contracts between particular customers and vendors, to create new vendor accounts, to manage existing contracts, to initiate billing, to rank customers and vendors, and/or for other similar purposes.

Vendor portal 64 may be dedicated for use by any number of vendors willing to provide discount prices for products and/or services to the customers of partner marketplace 16. The discount prices may be provided in exchange for increased volume created by the purchasing cooperative of partner marketplace 16. The products may include, among other things, vehicles 12, of receptacles 14, fuel, tires, batteries, replacement parts, etc. The services may include, for example, maintenance, repair, and data management. It is contemplated that any number of portals 64 may be simultaneously connected to network interface 58 for use by any number of different vendors associated with the same or different accounts. Each such portal 64 may allow the vendor to log into system 46 (e.g., via a web-based program, an internet site, or a mobile app) and to view existing contracts awarded to the particular vendor; to view and respond to open opportunities for products and/or services; to request and/or provide information regarding past and open contracts or opportunities; to monitor live or near-live maintenance and/or repair events; to submit invoices for completed services or purchased products; and for other purposes.

Service portal 66 may dedicated to the input of information generated by devices located onboard and/or around vehicles 12 and receptacles 14. In some examples, the information is automatically provided by way of location device 38 and sensors 42. In other examples, the information is manually provided by way of input device(s) 40. The information may include, for example, the location of each vehicle 12, a travel path, a schedule of stops, a status of a particular service event (e.g., if the service has been started, is ongoing, has been completed, or is problematic), vehicle condition and/or status information, receptacle condition and/or status information, and other information.

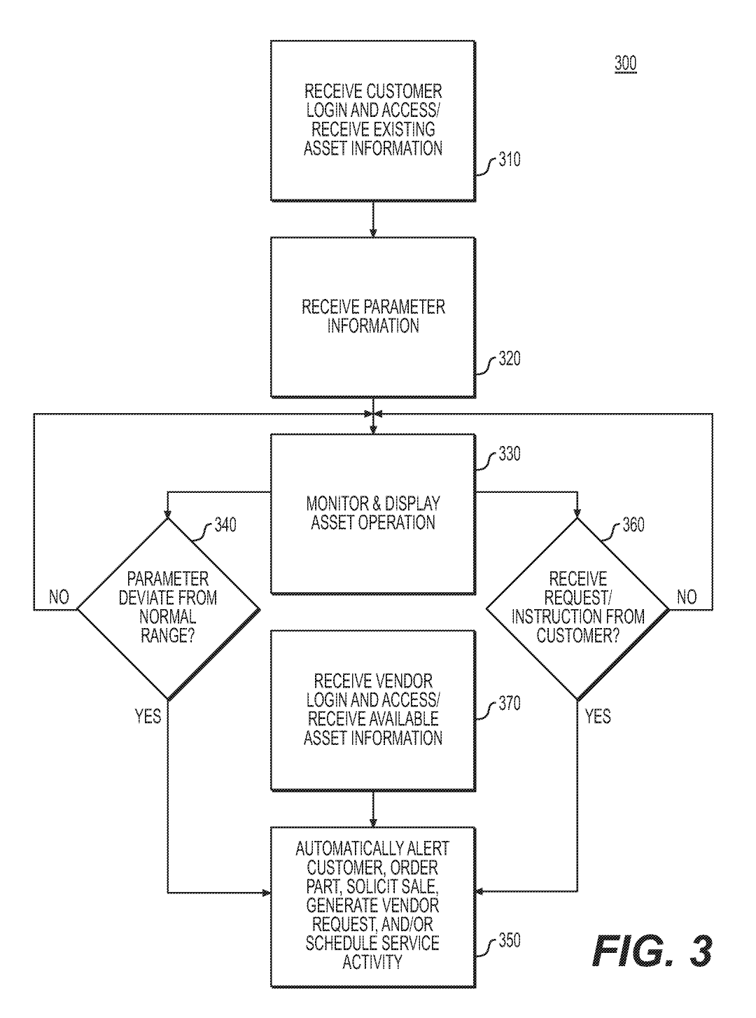

Based on the information received from portals 60-66, CPU 32 can be configured to execute instructions stored on computer readable medium to perform methods of fleet and/or waste-related product and service management at environment 10 (e.g., via partner marketplace 16). For example, CPU 32 may be configured to determine a particular need (e.g., maintenance, repair, replacement part, or other need) for a particular customer, and to automatically suggest and/or arrange for a solution to the need. The solution may include, among other things, completing a sale transaction for a product with a participating vendor on behalf of the customer, soliciting the vendor, and/or providing information (e.g., alerts, technical updates, service instructions, etc.) to the customer. The sales transaction may include, for example, ordering a part and/or scheduling a maintenance or repair service. This process is illustrated as an exemplary method 300 in FIG. 3. Method 300 will be explained in more detail in the following section to further illustrate the disclosed concepts.

### INDUSTRIAL APPLICABILITY

The disclosed system may be applicable to the waste service industry, and function to create a purchasing cooperative that connects subscribing waste service providers with corresponding vendors of waste-related products and services. The disclosed cooperative may increase the purchasing power of the service providers by creating a collective demand for a greater number of products and services, while also automating many diagnostic and logistic functions associated with maintenance and repair. This may help to lower operating costs, while also reducing vehicle downtime. Operation of system 46 will now be described with reference to FIG. 3.

Method 300 may be initiated by a customer via portal 60. In particular, login information may be received via portal 60 that uniquely identifies the customer and allows CPU 32 to access and/or receive information pertaining to one or more assets owned by the customer (Step 310). These assets may include, for example, one or more vehicles 12 and/or receptacles 14. In some embodiments, the assets could also or alternatively include a compactor, a sorting machine, a recycling machine, a scale, or another waste-related device. The information may include an identification of the asset, a location of the asset, an age of the asset, a condition of the asset, a type of the asset, and/or information that allows CPU 32 to communicate with the asset (e.g., via network interface 58, service portal 66, communication device 44, and/or controller 30). Using this information, CPU 32 may be able to remotely monitor operation of the asset via locating device 38, input device 40, and/or sensors 42 (Step 330). In some instances, the monitored operation may be displayed for the customer at Step 330 (e.g., via customer portal 60).

While monitoring operation of the asset, CPU 32 may be configured to compare a monitored parameter of the asset (e.g., an odometer reading, a temperature, a pressure, a time since last service, an oil quality level, a vibration, etc.) to a normal, expected, and/or threshold range (Step 340). As long as the monitored parameter remains within the range, control may return from Step 340 to Step 330. However, when the monitored parameter deviates from the range, CPU 32 may automatically respond to the deviation (Step 370). This response may include, among other things, alerting the customer of the deviation (e.g., via customer portal 60), ordering a part know to be worn out or expected to wear out soon (e.g., via vendor portal 64), soliciting a sale of a product or service to the customer that should return the monitored parameter to the expected range, generating a request for a part or service from a participating vendor, and/or scheduling a service (e.g., maintenance or repair) activity. For example, based on an odometer reading exceeding an odometer threshold, CPU 32 may automatically schedule an oil change with partner marketplace 16 and alert the customer of the need to change the oil and of the already-scheduled service.

In some instances, CPU 32 may receive a request and/or an instruction from the customer before, during, and/or after completion of Step 340 (Step 360). The request may be associated with any of the actions taken by CPU 32 at Step 350. In other words, instead of automatically performing Step 350, any one or more of the action of Step 350 may be initiated in direct response to input from the customer received via customer portal 60.

In some embodiments, actions taken by a participating vendor may trigger the completion of Step 350 by CPU 32. For example, a vendor may login to system 46 via vendor portal 64, and associated information may be received by CPU 32 from the vendor. This information may include, among other things, notification of a sale on products and/or services of interest to participating customers, notifications of recalls, notification of technical updates associated with particular assets, maintenance suggestions, etc. In response to this information, CPU 32 and/or the customer may initiate Step 350.

It will be apparent to those skilled in the art that various modifications and variations can be made to the disclosed system. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A system for managing waste services, comprising:
a plurality of first portals configured to receive waste-related asset information from a plurality of customers;
a plurality of second portals configured to receive waste-related asset information from a plurality of vendors; and
a central processing unit in electronic communication with the pluralities of first and second portals and being configured to:
monitor operation of customer assets based on the waste-related asset information received from the plurality of customers;
make a determination that an operating parameter of a particular customer asset has deviated from an acceptable range based on the monitored operation; and
automatically complete a sales transaction with a particular one of the plurality of vendors on behalf of a particular one of the plurality of customers based on the determination and based on the waste-related asset information received from the plurality of vendors.

2. The system of claim 1, wherein the particular customer asset is one of a service vehicle and a receptacle.

3. The system of claim 1, wherein the sales transaction is associated with one of a product sale and a sale of maintenance or repair services.

4. The system of claim 3, wherein the product sale includes one of a fuel sale, a tire sale, a battery sale, and a sale of a repair part.

5. The system of claim 1, further including a sensor configured to generate a signal directed to the central processing unit that is indicative of the operating parameter.

6. The system of claim 5, wherein the operating parameter is includes at least one of a distance traveled, a time since last service, a temperature, a pressure, a force, a speed, a motion, and a vibration.

7. The system of claim 1, wherein the central processing unit is further configured to selectively alert the particular one of the plurality of customers via a corresponding one of the plurality of first portals when the operating parameter of the particular customer asset has deviated from the acceptable range.

8. The system of claim 1, wherein the plurality of vendors provide discount pricing to the plurality of customers in exchange for high-volume sales collectively transacted on behalf of the plurality of customers.

9. The system of claim 1, further including a plurality of locating devices associated with the customer assets, wherein the central processing unit is configured to monitor operation of the customer assets based on signals generate by the plurality of locating devices.

10. The system of claim 1, further including a plurality of manual input devices associated with the customer assets, wherein the central processing unit is configured to monitor operation of the customer assets based on signals generate by the plurality of manual input devices.

11. A method for managing waste-related activities, the method comprising:
receiving waste-related asset information from a plurality of customers;
receiving waste-related asset information from a plurality of vendors;
monitoring operation of customer assets based on the waste-related asset information received from the plurality of customers;
making a determination that an operating parameter of a particular customer asset has deviated from an acceptable range based on the monitored operation; and
automatically completing a sales transaction with a particular one of the plurality of vendors on behalf of a particular one of the plurality of customers based on the determination and based on the waste-related asset information received from the plurality of vendors.

12. The method of claim 11, wherein the particular customer asset is one of a service vehicle and a receptacle.

13. The method of claim 11, wherein the sales transaction is associated with one of a product sale and a sale of maintenance or repair services.

14. The method of claim 13, wherein the product sale includes one of a fuel sale, a tire sale, a battery sale, and a sale of a repair part.

15. The method of claim 11, wherein the operating parameter is includes at least one of a distance traveled, a time since last service, a temperature, a pressure, a force, a speed, a motion, and a vibration.

16. The method of claim 11, further including selectively alerting the particular one of the plurality of customers when the operating parameter of the particular customer asset has deviated from the acceptable range.

17. The method of claim 11, wherein the plurality of vendors provide discount pricing to the plurality of customers in exchange for high-volume sales collectively transacted on behalf of the plurality of customers.

18. The method of claim 11, further including detecting a location of the customer assets, wherein monitoring operation of the customer assets includes monitoring operation of the customer assets based on the location of the customer assets.

19. The method of claim 11, further including receiving manual input from a plurality of operators of the customer assets, wherein monitoring operation of the customer assets includes monitoring operation of the customer assets based on the manual input.

20. A non-transitory computer readable medium containing computer-executable programming instructions for performing a method of managing waste-related activities, the method comprising:
receiving information from a plurality of customers in association with one of a waste service vehicle and a receptacle owned by the plurality of customers;
receiving information from a plurality of vendors regarding one of a product and a service available for the waste service vehicle or the receptacle;
monitoring operation of the waste service vehicle or the receptacle based on the information received from the plurality of customers;
making a determination that an operating parameter of a particular waste service vehicle or receptacle has deviated from an acceptable range based on the monitored operation; and
automatically completing a sales of the product or the service with a particular one of the plurality of vendors on behalf of a particular one of the plurality of customers based on the determination and based on the information received from the plurality of vendors, wherein the plurality of vendors provide discount pricing to the plurality of customers in exchange for high-volume sales collectively transacted on behalf of the plurality of customers.
